(19) United States
(12) Patent Application Publication
(10) Pub. No.: US 2026/0118303 A1
(43) Pub. Date: Apr. 30, 2026

(54) THERMAL MONITORING OF WEAR ITEMS ON A VOCATIONAL VEHICLE

(71) Applicant: Oshkosh Corporation, Oshkosh, WI (US)

(72) Inventors: Joe Nelson, Oshkosh, WI (US); Quincy Wittman, Oshkosh, WI (US); Vince Schad, Oshkosh, WI (US)

(73) Assignee: Oshkosh Corporation, Oshkosh, WI (US)

(21) Appl. No.: 19/003,659

(22) Filed: Dec. 27, 2024

Related U.S. Application Data
(60) Provisional application No. 63/615,700, filed on Dec. 28, 2023.

(51) Int. Cl. G01N 25/72

(52) U.S. Cl. CPC G01N 25/72

(57) ABSTRACT

A refuse vehicle includes a chassis, a body assembly coupled with the chassis, one or more wear components, one or more temperature sensors coupled with the one or more wear components, and a controller. The controller has one or more memory devices storing instructions thereon that, when executed by one or more processors, cause the one or more processors to perform operations. The operations include acquiring data indicative of a temperature of the one or more wear components from the one or more temperature sensors, acquiring a temperature threshold for the one or more wear components, and determining whether the temperature of the one or more wear components satisfies the temperature threshold. The operations further include operating a user device to display the temperature of the wear component in response to determining that the temperature of the wear component fails to satisfy the temperature threshold.

### CROSS-REFERENCE TO RELATED APPLICATIONS

This Application claims the benefit of and priority to U.S. Provisional Application No. 63/615,700, filed December 28, 2023, the entire contents of which are hereby incorporated by reference herein.

### BACKGROUND

The present invention relates generally to the field of refuse vehicles, and in particular, to the field of temperature monitoring.

### SUMMARY

One embodiment relates to a refuse vehicle. The refuse vehicle includes a chassis, a body assembly coupled with the chassis, one or more wear components, one or more temperature sensors coupled with the one or more wear components, and a controller. The controller has one or more memory devices storing instructions thereon that, when executed by one or more processors, cause the one or more processors to perform operations. The operations include acquiring data indicative of a temperature of the one or more wear components from the one or more temperature sensors, acquiring a temperature threshold for the one or more wear components, and determining whether the temperature of the one or more wear components satisfies the temperature threshold. The operations further include operating a user device to display the temperature of the wear component in response to determining that the temperature of the wear component fails to satisfy the temperature threshold.

Another embodiment relates to a control system for a vocational vehicle. The control system includes a controller having one or more memory devices storing instructions thereon that, when executed by one or more processors, cause the one or more processors to perform operations. The operations include acquiring data indicative of a temperature of the one or more wear components from the one or more temperature sensors, acquiring a temperature threshold for the one or more wear components, and determining whether the temperature of the one or more wear components satisfies the temperature threshold. The operations further include operating a user device to display the temperature of the wear component in response to determining that the temperature of the wear component fails to satisfy the temperature threshold.

Yet another embodiment relates to a method for monitoring temperature of wear components in a refuse vehicle. The method includes acquiring data indicative of a temperature of one or more wear components of the refuse vehicle from one or more temperature sensors, acquiring a temperature threshold for the one or more wear components, and determining whether the temperature of the one or more wear components satisfies the temperature threshold. The method further includes operating a user device to display the temperature of the wear component in response to determining that the temperature of the wear component fails to satisfy the temperature threshold.

### BRIEF DESCRIPTION OF DRAWINGS

FIG. 1 is a perspective view of a front loading refuse vehicle, according to exemplary embodiments;

FIG. 2 is a side view of a rear loading refuse vehicle, according to exemplary embodiments;

FIG. 3 is a perspective view of a side loading refuse vehicle, according to exemplary embodiments;

FIG. 4 is a perspective view of a lift assembly of the side loading refuse vehicle of FIG. 3;

FIG. 5 is a perspective view of a lift assembly of the side loading refuse vehicle of FIG. 3;

FIG. 6 is a perspective view of a grabber arm of the lift assembly of FIG. 5;

FIG. 7 is a perspective view of the lift assembly of FIG. 5;

FIG. 8 is an internal perspective view of a loading section of the side loading refuse vehicle of FIG. 3;

FIG. 9 is a perspective view of a packer positioned within the side loading refuse vehicle of FIG. 3;

FIG. 10 is a schematic diagram of a control system for a refuse vehicle, according to exemplary embodiments;

FIG. 11 is a flow diagram of a process for monitoring temperature of components of a refuse vehicle, according to exemplary embodiments;

FIG. 12 is a perspective view of a roller and a temperature sensor, according to exemplary embodiments;

FIG. 13 is a perspective view of a roller and a temperature sensor, according to exemplary embodiments;

FIG. 14 is a perspective view of a roller and a temperature sensor, according to exemplary embodiments;

FIG. 15 is a side view of a temperature sensor positioned partially within the roller of FIG. 14;

FIG. 16 is a perspective view of a roller and a temperature sensor, according to exemplary embodiments;

FIG. 17 is a perspective view of a roller and a temperature sensor, according to exemplary embodiments; and

FIG. 18 is a perspective view of a roller and a temperature sensor coupled to a side of the roller, according to exemplary embodiments.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, systems and methods for a temperature monitoring system of wear components are shown, according to various embodiments. As used herein, the term “wear component” means any of, or any combination of: rollers, bushings, bearings, pins, or wear shoes. Temperature sensors 100 may be coupled with the wear components by a plurality of methods and disposed in various locations of the refuse vehicle. The temperature measurements collected by temperature sensors 100 are transmitted to a controller configured to receive information from the temperature sensors 100. The information is received and processed by the controller and compared to a temperature threshold determined by the controller. If the measured temperature is higher than the identified temperature threshold, the controller may operate a display screen to display a warning that the measured temperature is outside of normal limits, according to exemplary embodiments. In some embodiments, the displayed warning may further include possible causes of the high temperature measurement, such as damage to the wear component or lack of lubrication. If the measured temperature is within the identified temperature threshold, the controller may operate the display screen to show that wear component temperature measurements are within normal limits.

### Refuse Vehicle

### Front-Loading Configuration

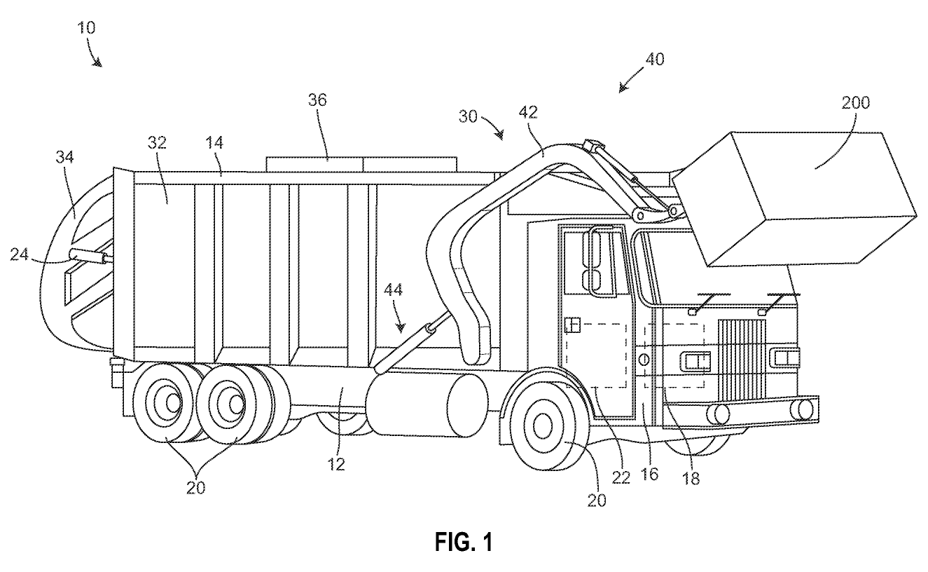

Referring to FIG. 1, a vocational vehicle, shown as refuse vehicle 10 (e.g., a garbage truck, a waste collection truck, a sanitation truck, etc.), is shown that is configured to collect and store refuse along a collection route. In the embodiment of FIG. 1, the refuse vehicle 10 is configured as a front-loading refuse vehicle. The refuse vehicle 10 includes a chassis, shown as frame 12; a body assembly, shown as body 14, coupled with the frame 12 (e.g., at a rear end thereof, etc.); and a cab, shown as cab 16, coupled with the frame 12 (e.g., at a front end thereof, etc.). The cab 16 may include various components to facilitate operation of the refuse vehicle 10 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 10 includes a prime mover, shown as engine 18, coupled with the frame 12 at a position beneath the cab 16. The engine 18 is configured to provide power to tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, bio-diesel, ethanol, natural gas, etc.), according to various exemplary embodiments. The fuel may be stored in a tank 28 (e.g., a vessel, a container, a capsule, etc.) that is fluidly coupled with the engine 18 through one or more fuel lines.

According to an alternative embodiment, the engine 18 additionally or alternatively includes one or more electric motors coupled with the frame 12 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 10. The engine 18 may transfer output torque to or drive the tractive elements 20 (e.g., wheels, wheel assemblies, etc.) of the refuse vehicle 10 through a transmission 22. The engine 18, the transmission 22, and one or more shafts, axles, gearboxes, etc., may define a driveline of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter transferred and/or compacted into the storage volume. According to an exemplary embodiment, the hopper volume is positioned forward of the cab 16 (e.g., refuse is loaded into a position of the refuse compartment 30 in front of the cab 16, a front-loading refuse vehicle, etc.). In other embodiments, the hopper volume is positioned between the storage volume and the cab 16 (e.g., refuse is loaded into a position of the refuse compartment 30 behind the cab 16 and stored in a position further toward the rear of the refuse compartment 30). In yet other embodiments, the storage volume is positioned between the hopper volume and the cab 16 (e.g., a rear-loading refuse vehicle, etc.).

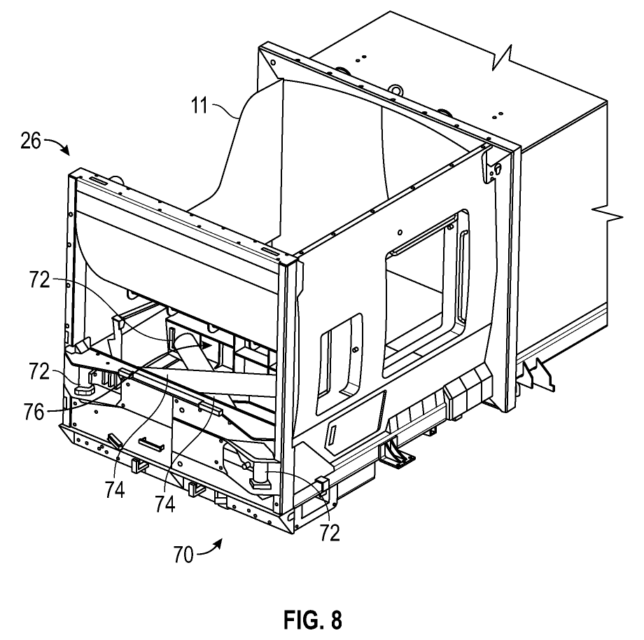

The tailgate 34 may be hingedly or pivotally coupled with the body 14 at a rear end of the body 14 (e.g., opposite the cab 16). The tailgate 34 may be driven to rotate between an open position and a closed position by tailgate actuators 24. The refuse compartment 30 may be hingedly or pivotally coupled with the frame 12 such that the refuse compartment 30 can be driven to raise or lower while the tailgate 34 is open in order to dump contents of the refuse compartment 30 at a landfill. The refuse compartment 30 may include a packer assembly 70 (e.g., a compaction apparatus) (shown in FIGS. 8-9) positioned therein that is configured to compact loose refuse.

Referring still to FIG. 1, the refuse vehicle 10 includes a first lift mechanism or system (e.g., a front-loading lift assembly, etc.), shown as lift assembly 40. The lift assembly 40 includes a pair of arms, shown as lift arms 42, coupled with at least one of the frame 12 or the body 14 on either side of the refuse vehicle 10 such that the lift arms 42 extend forward of the cab 16 (e.g., a front-loading refuse vehicle, etc.). The lift arms 42 may be rotatably coupled with frame 12 with a pivot (e.g., a lug, a shaft, etc.). The lift assembly 40 includes first actuators, shown as lift arm actuators 44 (e.g., hydraulic cylinders, etc.), coupled with the frame 12 and the lift arms 42. The lift arm actuators 44 are positioned such that extension and retraction thereof rotates the lift arms 42 about an axis extending through the pivot, according to an exemplary embodiment. Lift arms 42 may be removably coupled with a container, shown as refuse container 200 in FIG. 1. Lift arms 42 are configured to be driven to pivot by lift arm actuators 44 to lift and empty the refuse container 200 into the hopper volume for compaction and storage. The lift arms 42 may be coupled with a pair of forks or elongated members that are configured to removably couple with the refuse container 200 so that the refuse container 200 can be lifted and emptied. The refuse container 200 may be similar to the refuse container 200 as described in greater detail in U.S. Application No. 17/558,183, filed December 12, 2021, the entire disclosure of which is incorporated by reference herein.

### Rear-Loading Configuration

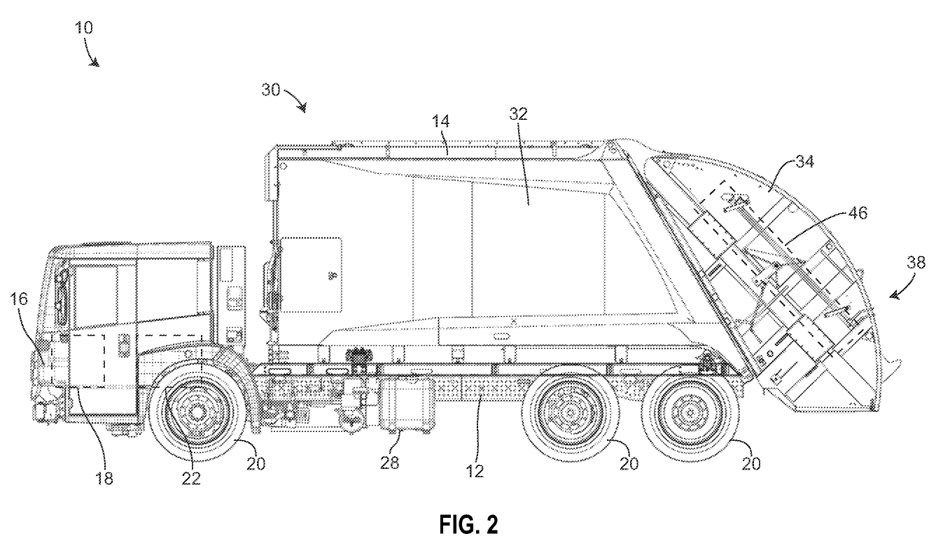

As shown in FIG. 2, the refuse vehicle 10 may be configured as a rear-loading refuse vehicle, according to some embodiments. In the rear-loading embodiment of the refuse vehicle 10, the tailgate 34 defines an opening 38 through which loose refuse may be loaded into the refuse compartment 30. The tailgate 34 may also include a packer 46 (e.g., a packing assembly, a compaction apparatus, a claw, a hinged member, etc.) that is configured to draw refuse into the refuse compartment 30 for storage. Similar to the embodiment of the refuse vehicle 10 described in FIG. 1 above, the tailgate 34 may be hingedly coupled with the refuse compartment 30 such that the tailgate 34 can be opened or closed during a dumping operation

### Side-Loading Configuration

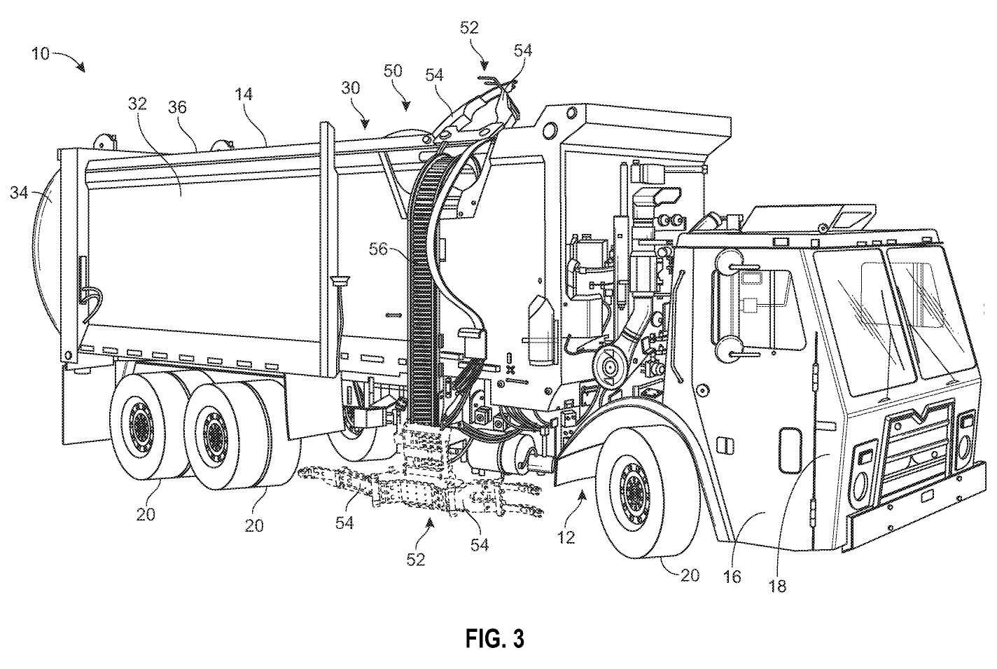

Dddd Referring to FIG. 3, the refuse vehicle 10 may be configured as a side-loading refuse vehicle (e.g., a zero radius side-loading refuse vehicle). The refuse vehicle 10 includes first lift mechanism or system, shown as lift assembly 50. Lift assembly 50 includes a grabber assembly, shown as grabber assembly 52, movably coupled with a track, shown as track 56, and configured to move along an entire length of track 56. According to the exemplary embodiment shown in FIG. 3, track 56 extends along substantially an entire height of body 14 and is configured to cause grabber assembly 52 to tilt near an upper height of body 14. In other embodiments, the track 56 extends along substantially an entire height of body 14 on a rear side of body 14. The refuse vehicle 10 can also include a reach system or assembly coupled with a body or frame of refuse vehicle 10 and lift assembly 50. The reach system can include telescoping members, a scissors stack, etc., or any other configuration that can extend or retract to provide additional reach of grabber assembly 52 for refuse collection.

Referring still to FIG. 3, grabber assembly 52 includes a pair of grabber arms shown as grabber arms 54a and 54b . The grabber arms 54a, 54b are configured to rotate about an axis extending through a bushing. The grabber arms 54a, 54b are configured to releasably secure a refuse container to grabber assembly 52, according to an exemplary embodiment. The grabber arms 54a, 54b rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 54a, 54b are rotated towards each other such that the refuse container is grasped therebetween. In the disengaged state, the grabber arms 54a, 54b rotate outwards such that the refuse container is not grasped therebetween. By transitioning between the engaged state and the disengaged state, the grabber assembly 52 releasably couples the refuse container with grabber assembly 52. The refuse vehicle 10 may pull up along-side the refuse container, such that the refuse container is positioned to be grasped by the grabber assembly 52 therebetween. The grabber assembly 52 may then transition into an engaged state to grasp the refuse container. After the refuse container has been securely grasped, the grabber assembly 52 may be transported along track 56 with the refuse container. When the grabber assembly 52 reaches the end of track 56, the grabber assembly 52 may tilt and empty the contents of the refuse container in refuse compartment 30. The tilting is facilitated by the path of the track 56. When the contents of the refuse container have been emptied into refuse compartment 30, the grabber assembly 52 may descend along the track 56 and return the refuse container to the ground. Once the refuse container has been placed on the ground, the grabber assembly may transition into the disengaged state, releasing the refuse container.

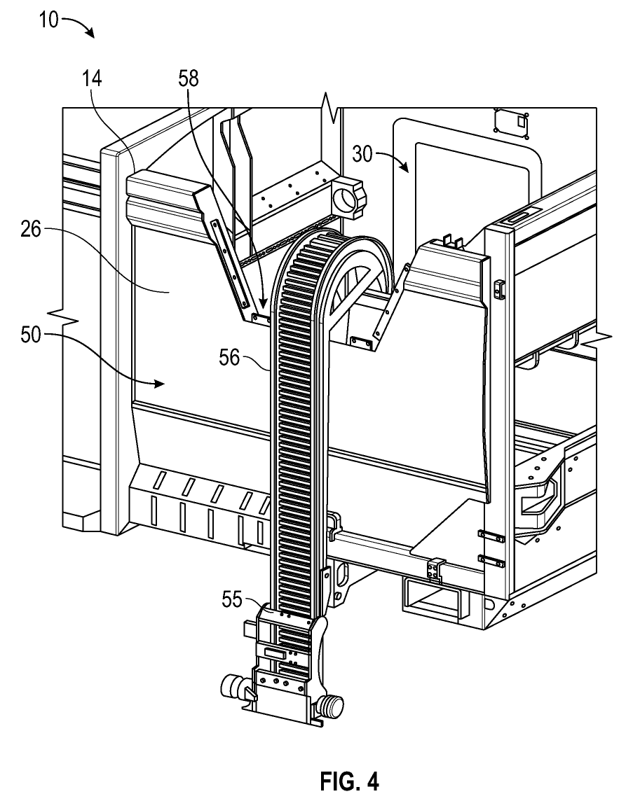

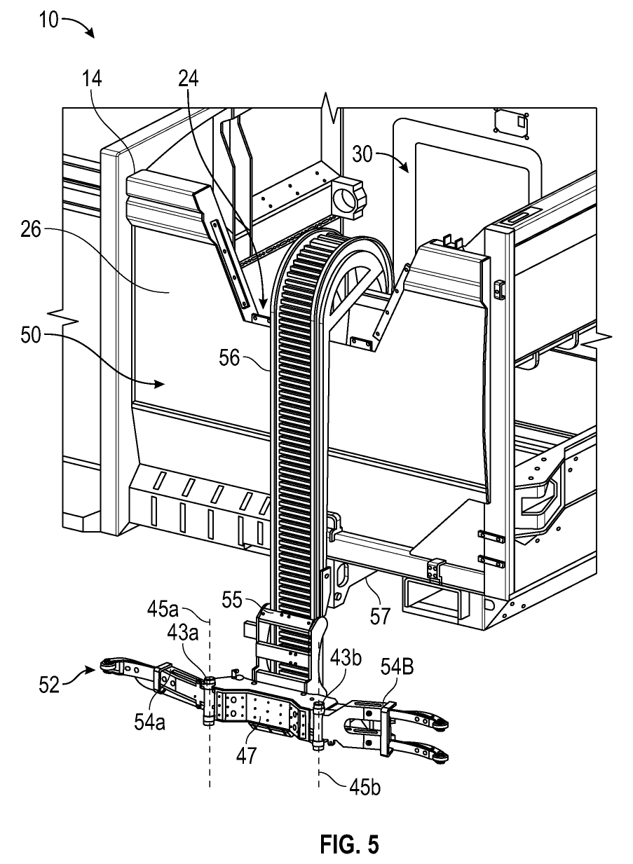

Referring now to FIGS. 4-5, the lift assembly 50 is shown in greater detail, according to an exemplary embodiment. The lift assembly 50 is shown to include track 56, and a connecting member, shown as connecting member 55. The track 56 is configured to extend along substantially an entire height of the body 14, according to the exemplary embodiment shown. The body 14 is shown to include a loading section 26 having a recessed portion, shown as recessed portion 58. The recessed portion 58 is configured such that track 56 curves through recessed portion 58, thereby facilitating emptying (e.g., into refuse compartment 30) of a refuse bin (e.g., a garbage can) releasably coupled with grabber assembly 52.

A connecting member 55 is shown translationally coupled with track 56. Connecting member 55 is coupled with track 56 (e.g., through rollers, slidable bearings, etc.) such that connecting member 55 may move along an entire path length of track 56. Connecting member 55 may removably and fixedly couple with grabber assembly 52 to facilitating transportation of grabber assembly 52 along the entire path length of track 56. The grabber assembly 52 is shown to include grabber arms, grasping members, elongated members, etc., shown as first grabber arm 54a and second grabber arm 54b. The first grabber arm 54a and second grabber arm 54b are each configured to pivot about 45a and axis 45b, respectively. Axis 45a is defined as an axis extending longitudinally through a first adapter assembly (e.g., a bushing), shown as first adapter assembly 43a, and axis 45b is defined as an axis longitudinally extending through a second adapter assembly (e.g., a bushing), shown as second adapter assembly 43a. First adapter assembly 43a rotatably couples with first grabber arm 44a. Second adapter assembly 43b rotatably couples with second grabber arm 44b. First adapter assembly 43a and second adapter assembly 43b rotatably (e.g., hingedly, pivotably, etc.) couple first grabber arm 44a and second grabber arm 44b with carriage 46 to facilitate rotation of first grabber arm 44a and second grabber arm 44b about axis 45a and axis 45b, respectively.

As shown in FIGS. 4-5, the lift assembly 50 includes a boom arm 57 coupled with the track 56. The boom arm 57 may extend and retract to translate the track 56 and the grabber assembly 52 thereon outwards. The boom arm 57 facilitates reaching refuse containers with grabber assembly 52 that may be positioned a distance away from refuse vehicle 10. In some examples, the boom arm 57 is a telescoping apparatus with an inner and outer member. The boom arm 57 can include any number of telescoping portions to improve an overall reach capability (e.g., a maximum extension length) of the grabber assembly 52. The various telescoping members can be driven to extend or retract using an electric motor, a linear electric actuator, gearboxes, etc., thereby providing a fully-electric boom arm 57.

### Temperature Monitoring of Wear Items

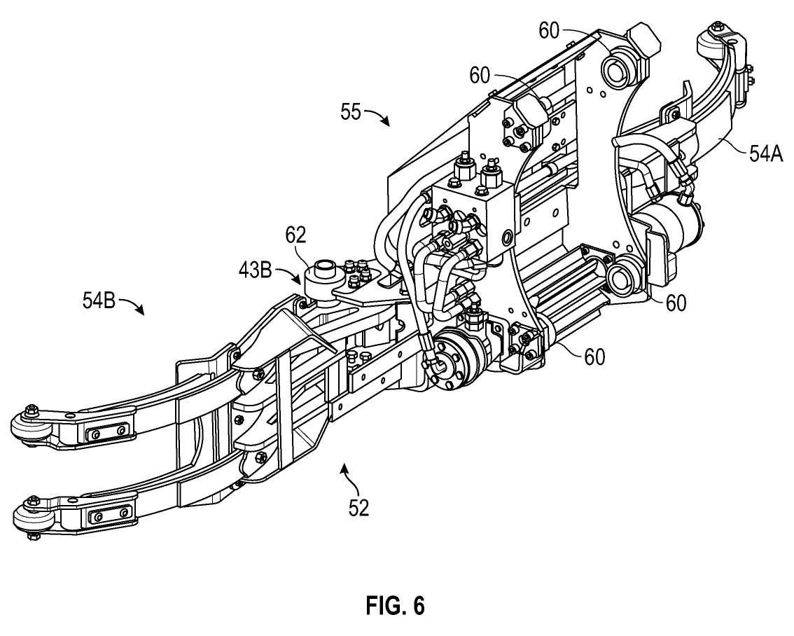

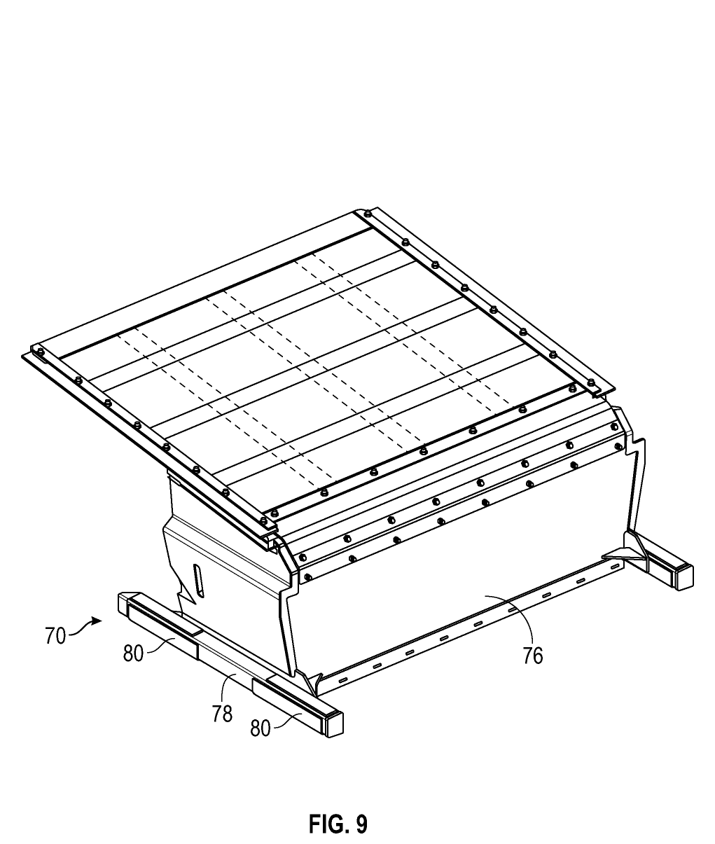

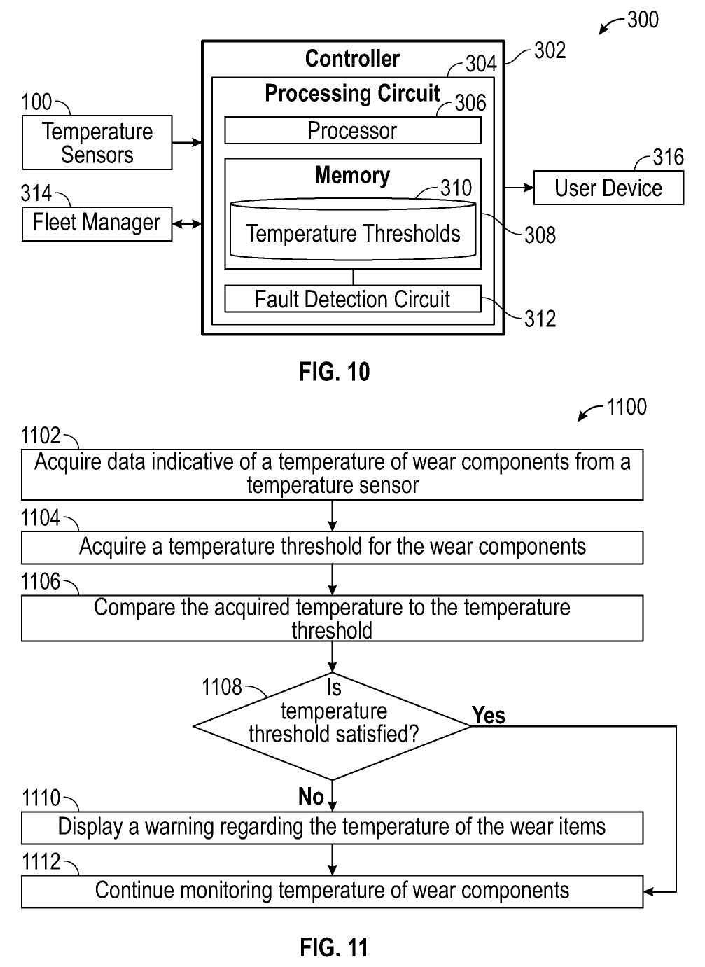

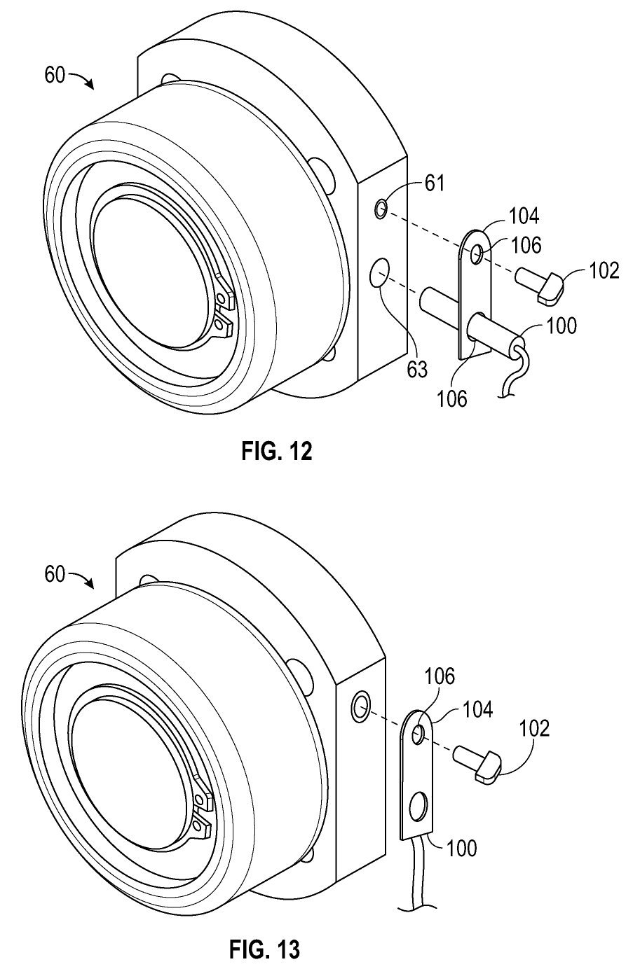

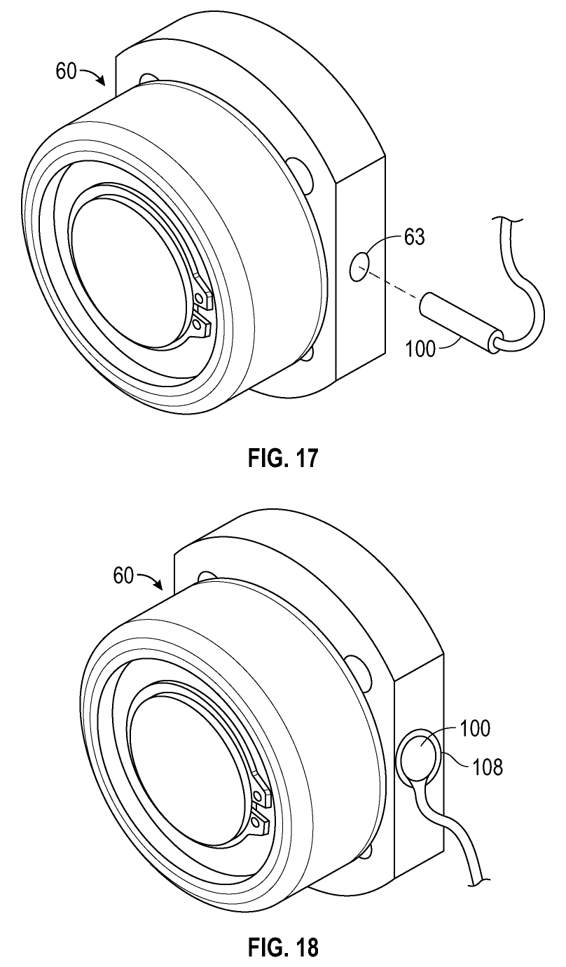

Referring generally to FIGS. 6-9, perspective views of various assemblies on the refuse vehicle 10 are shown. Each of the assemblies shown (e.g., the grabber arm assembly 52, the packer assembly 70, etc.) include one or more components that may experience higher rates of wear than other assemblies on the refuse vehicle 10 (e.g., due to more frequent use during operations, high friction processes, mechanical stress, abrasive or harsh environmental conditions, etc.). In general, one or more temperature sensor(s) 100 (shown in FIGS. 12-18) may coupled with the assemblies shown in FIGS. 6-9 to enable the temperature monitoring of one or more components of the assemblies. The temperature sensors 100 acquire data indicative of or, if virtual, determine or receive an approximate temperature of various components or systems at or approximately at the disposed location(s) of the temperature sensors 100. The temperature sensors 100 may be communicatively coupled with a controller 302 (shown in FIG. 10) and may transmit the temperature information to the controller 302.

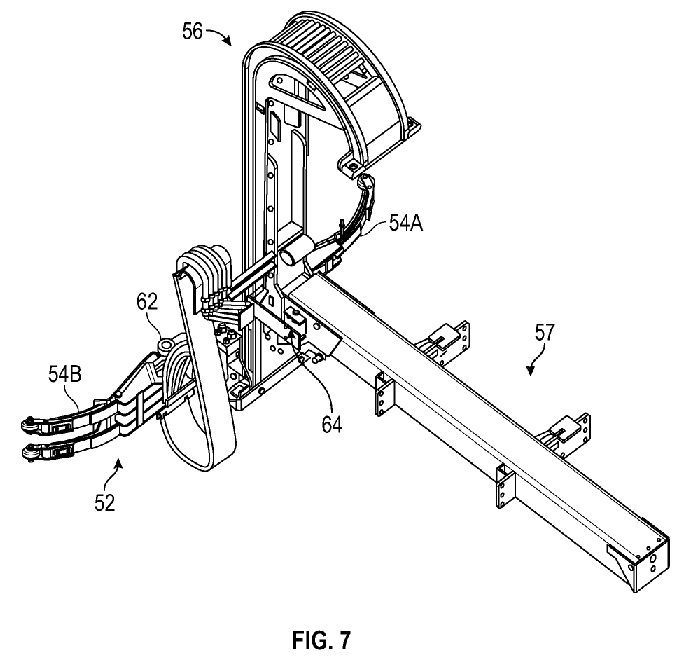

Referring now to FIGS. 6 and 7, perspective views of the lift assembly 50 and grabber arm assembly 52 are shown, according to exemplary embodiments. As discussed above, each grabber arm 54a, 54b includes an adapter assembly 43a, 43b that allow the grabber arms 54a, 54b to rotate to open and close. As shown in FIG. 6, a bushing 62 is positioned on one or both ends of the adapter assemblies 43a, 43b. The connecting member 55 is shown to include a plurality of rollers 60. In this example, the connecting member 55 is coupled with the track 56 via the rollers 60. In this way, the rollers 60 allow the connecting member 55 and the grabber arms 54a, 54b thereon to translate along the length of the track 56.

As shown in FIG. 7, the boom arm 57 includes a boom roller 64 arranged at an interface between a boom arm 57 and the grabber arm assembly 52 to facilitate extension of the grabber arm assembly 52 outwardly relative to the body 14 of the refuse vehicle 10. Since the rollers 60, 64 and bushings 62 facilitate motion between components of the lift assembly 50, the rollers 60, 64 and bushings 62 may experience higher rates of wear relative to other components of the lift assembly 50 (e.g., due to friction, insufficient lubrication, contact stress, etc.). One or more temperature sensors 100 may be positioned within or coupled with the surface of the rollers 60, 64, and/or the bushing 62. In this way, the temperature sensors may measure temperature data associated with the rollers 60, 64, and/or the bushing 62. Such temperature data may be utilized (e.g., by the controller 302) to monitor the wear or strain on the rollers 60, 64, and the bushing 62.

Referring now to FIGS. 8 and 9, the loading section 26 and packer assembly 70 therein are shown in greater detail. The packer assembly 70 includes one or more packing actuators 74 configured to expand and retract to translate a packer 76 along rails 78 within the loading section 26. One or more pins 72 may be arranged at an interface between packing actuators 74 and the body 14 and/or at an interface the packing actuators 74 and the packer 76. In some embodiments, two of the pins 72 are arranged at the interface between the packing actuators 74 and the body 14, and two other pins 72 are arranged at the interface between the packing actuators 74 and the packer 76. The pins 72 may experience higher rates of wear relative to other components within the loading section 26 (e.g., due to pivoting of the packing actuators 74 that occurs during operation). Accordingly, temperature sensors 100 may be positioned within or coupled with the surface of the pins 72 to monitor the wear on the pins 72.

The packer 76 is shown to be coupled with sliding rails 78 and wear shoes 80. During operation, the sliding rails 78 are arranged within a track that extends longitudinally along an interior of the body 14 (e.g., through the refuse compartment 30) to guide the packer 76 during extension and retraction by the packing actuators 74. The wear shoes 80 are arranged at the interface between the sliding rails 78 and the track to reduce metal-to-metal wear at the interface. Since the wear shoes 80 facilitate motion between the packer 76 and the track/railings within the body 14, the wear shoes may experience higher rates of wear relative to other components within the loading section 26 (e.g., due to friction, insufficient lubrication, contact stress, etc.). One or more temperature sensors may be positioned within or coupled with the surface of the wear shoes 80. In this way, the temperature sensors may measure temperature data associated with wear shoes 80. Such temperature data may be utilized (e.g., by a controller) to monitor the wear or strain on the wear shoes 80.

Referring now to FIG. 10, a block diagram of a control system 300 for temperature monitoring of wear components in a refuse vehicle (e.g., the refuse vehicle 10) is shown, according to exemplary embodiments. The controller 302 may be disposed in any suitable location on the refuse vehicle 10. The controller 302 is shown to include a circuit, shown as processing circuit 304, a processor, shown as processor 306, and memory, shown as memory 308. The processing circuit 304 may include one or more specialized circuits, shown as temperature monitoring circuit 312. Controller 302 may be implemented as a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. The processing circuit 304 may include an ASIC, one or more FPGAs, a DSP, circuits containing one or more processing components, circuitry for supporting a microprocessor, a group of processing components, or other suitable electronic processing components (e.g., processor 306). In some embodiments, processing circuit 304 is configured to execute computer code stored in the memory 308 or the specialized circuits to facilitate the activities described herein.

The memory 308 may be any volatile or non-volatile computer-readable storage medium capable of storing data or computer code relating to the activities described herein. According to an exemplary embodiment, memory 308 includes computer code modules (e.g., executable code, object code, source code, script code, machine code, etc.) configured for execution by processing circuit 304. In some embodiments, controller 302 may represent a collection of processing devices (e.g., servers, data centers, etc.). In such cases, processing circuit 304 represents the collective processors of the devices, and memory 308 represents the collective storage devices of the devices.

The temperature sensor(s) 100 may measure the temperature of the wear components (e.g., the rollers 60, the grabber bushings 62, the boom roller 64, the pins 72, the wear shoes 80, etc.) throughout the refuse vehicle 10 and transmit the temperature data associated with the one or more wear components to the controller 302. It should be appreciated that any of the temperature sensors 100 described herein may be installed on all of the wear components, or a combination of the wear components (e.g., the rollers 60, the grabber bushings 62, the pins 72, the wear shoes 80, and/or the boom roller 64). The temperature sensor(s) 100 may transmit data indicative of the temperature of the wear components to the controller 302 in real time or nearly real time, or in preset increments (e.g., every 1-15 minutes, 30 minutes, hourly, daily, etc.).

A fleet manager 314 may be communicatively coupled with the controller 302, such that the fleet manager 314 and the controller may exchange data. In this way, the fleet manager may receive temperature data from temperature sensors 100 disposed throughout a fleet of refuse vehicles 10. The fleet manager may transmit fleet temperature data to the controller 302, so that the controller 302 may compare temperature data from the temperature sensors 100 positioned on the refuse vehicle 10 with the fleet temperature data.

The memory is shown to include a database 310 storing temperature thresholds. The temperature thresholds may define normal or regular temperatures for the various wear components (e.g., the rollers 60, 64, the bushing 62, the wear shoes 80, etc.). In some examples, the temperature thresholds are preset (e.g., by the fleet manager 314, by a provider or manufacturer of the refuse vehicle 10, etc.). In other examples, the controller 302 may determine temperature thresholds based on fleet temperature data for various wear components throughout a fleet of refuse vehicles 10. For example, the controller 302 may determine a temperature threshold by averaging the temperature data for each wear component, by applying a model (e.g., a statistical model, a machine learning model, etc.), or by applying a filter to eliminate outliers (e.g., sudden spikes or drops in temperature, etc.) to determine a range of average temperatures. Additionally or alternatively, the memory 308 may store the temperature measurements from temperature sensor(s) 100 on the associated refuse vehicle 10 (e.g., the refuse vehicle 10 the controller 302 is disposed on). The historical temperature data may be used by the controller 302 to determine a temperature threshold to be used in the future for a particular wear component. By way of example, the memory 308 may store temperature data for the bushing 62 coupled with the adapter assembly 43a over the course of a year. The controller 302 may utilize the temperature data for the bushing 62 coupled with the adapter assembly 43a to determine a temperature threshold for that specific bushing 62 (e.g., by determining an average temperature or average range of temperatures over the year, by applying a model, etc.).

The temperature monitoring circuit 312 may compare the temperature data received from the temperature sensors 100 to the temperature thresholds. If the temperature of the wear components fail to satisfy the temperature thresholds (e.g., the temperature exceeds an upper limit or falls below a lower limit, etc.), the controller 302 may cause a user device 316 (e.g., a mobile device, a computer, laptop, tablet, a dashboard display within the cabin 16, etc.) to display a user interface indicating the abnormal temperature (e.g., displaying a written warning, a symbol, etc.). For example, the controller 302 may cause the user device 316 to display a notification and/or activate an alarm (e.g., sound, vibration, audial-visual display, etc.). In some embodiments, the user interface may further include possible causes of the wear component’s high temperature measurement, such as damage to the wear component or lack of lubrication. If the measured temperature of the wear components satisfy the temperature threshold, then the controller 302 may operate user device 316 to show that wear component temperature measurements are within normal limits.

Referring now to FIG. 11, a flow chart of the process or method 1100 for monitoring temperature of wear components is shown, according to an exemplary embodiment. The process 1100 may be performed by the controller 302.

At step 1102, the controller 302 acquires data indicative of a temperature of one or more wear components within the refuse vehicle 10. As discussed above, the wear components may include rollers 60, boom rollers 64, bushings 62, and wear shoes 80, according to some examples. A temperature sensor 100 or multiple temperature sensors 100 may be coupled with the wear components, such that the temperature sensors 100 may measure the internal and/or surface temperatures of the wear components. In some examples, the temperature sensors 100 measure operating temperatures of the wear components (e.g., the temperature of the wear components when the refuse vehicle 10 is on, a particular assembly is active or in use, etc.). For example, a temperature sensor 100 coupled with the rollers 60 may measure/collect temperature data while the lift assembly 50 is active and/or while the grabber assembly 52 translates relative to the track 56. In some embodiments, the hydraulic temperature of the hydraulic components (e.g., pumps, motors, actuators, etc.) on the refuse vehicle 10 may be monitored via temperature sensors 100.

At step 1104, the controller 302 acquires a temperature threshold for one or more of the wear components. As discussed above, the temperature thresholds may be preset values, or the temperature thresholds may be determined by the controller 302. In other examples, the fleet manager 314 may determine temperature thresholds for the wear components (e.g., based on fleet temperature data) and transmit the temperature thresholds to the controller 302. The temperature thresholds may include a range of acceptable or normal temperature values for a particular wear component. In some examples, the temperature thresholds are based on the operating temperatures of the wear components rather than the temperature of the wear components while not in use (e.g., while the refuse vehicle 10 is off, while the assembly the wear component is positioned on or within is inactive, etc.).

At step 1106, the controller 302 compares the acquired/received temperatures for the wear components to an associated temperature threshold, to determine whether the temperature threshold is satisfied (step 1108). If the acquired temperature for a wear component satisfies the temperature threshold associated with that particular wear component or type of wear component, then the controller 302 proceeds to step 1112. At step 1112, the controller 302 continues to monitor the temperature of the wear components. If the acquired temperature for the wear component does not satisfy the temperature threshold associated with it, then the controller 302 proceeds to step 1110.

At step 1110, the controller 302 causes a user device (e.g., user device 316) to display a user interface indicating the abnormal temperature (e.g., displaying a written warning, a symbol, etc.). For example, the controller 302 may receive data indicative of a temperature of a first roller from a temperature sensor. The controller 302 may then compare the temperature of the first roller to a preset temperature threshold that defines a maximum acceptable temperature for the first roller. If the temperature of the first roller exceeds the preset temperature threshold, then the controller 302 may generate a user interface including a graphical representation of the temperature of the first roller. The graphical representation may include, for example, the current temperature of the first roller, the temperature threshold, and a written warning indicating that the first roller is above a maximum temperature. For example, the interface might display a red warning symbol next to the affected component's name or identifier. Additionally or alternatively, the user interface may include a written message detailing the nature of the issue, such as “Warning: Roller 1 Temperature Exceeds Limit.” The graphical representation may include additional information, such as a timestamp of when the temperature data was received and a location of the roller. In some examples, the controller 302 may generate recommendations for the user/operator. For example, the user interface might include suggested actions such as “Inspect Roller 1 for misalignment” or "Reduce load on the lift assembly to prevent further temperature rise."

Referring now to FIGS. 12-18, perspective views of the rollers 60 and various temperature sensor 100 arrangements are shown, according to exemplary embodiments. As shown in FIGS. 12-18, the roller 60 includes openings 61, 63 configured to receive a bolt 102 and/or a temperature sensor 100 (e.g., a temperature sensor within a ferrule, a thermal probe, a thermistor, a thermocouple, etc.). The opening 61 is shown to include threading around its interior circumference, such that the bolt 102 may threadedly couple with the opening 61. In some examples, the opening 63 may be a smooth opening configured to receive the temperature sensor 100, as shown in FIGS. 8 and 13. In other examples, the opening 63 may include threading around its interior circumference such that the temperature sensor 100 may be threadedly coupled with the opening 63, as shown in FIG. 10.

Referring specifically to FIG. 12, the temperature sensor 100 may be affixed to the roller 60 such that the temperature sensor 100 extends into the interior of the roller 60. As shown in FIG. 12, the temperature sensor may be coupled with the roller 60 using a mounting plate 104. The mounting plate 104 includes one or more openings 106 that may be aligned with the openings 61, 63. To install the temperature sensor 100, the sensor and a bolt 102 are inserted through the openings 106 in the mounting plate 104 and into the corresponding openings 61, 63 in the roller 60. The bolt 102 is turned to threadedly couple with the opening 61, thereby affixing the mounting plate 104 and the temperature sensor 100 to the roller 60.

In some examples, the mounting plate 104 includes a single opening 61 for receiving the bolt 102. For example, as shown in FIG. 13, the temperature sensor 100 may be coupled to a surface of the mounting plate 104. Additionally or alternatively, the mounting plate 104 may include a housing that holds the temperature sensor 100. In this way, the mounting plate 104 may be affixed to the exterior of the roller 60 using the bolt 102, thereby allowing the temperature sensor 100 to rest against or near the exterior of the roller 60.

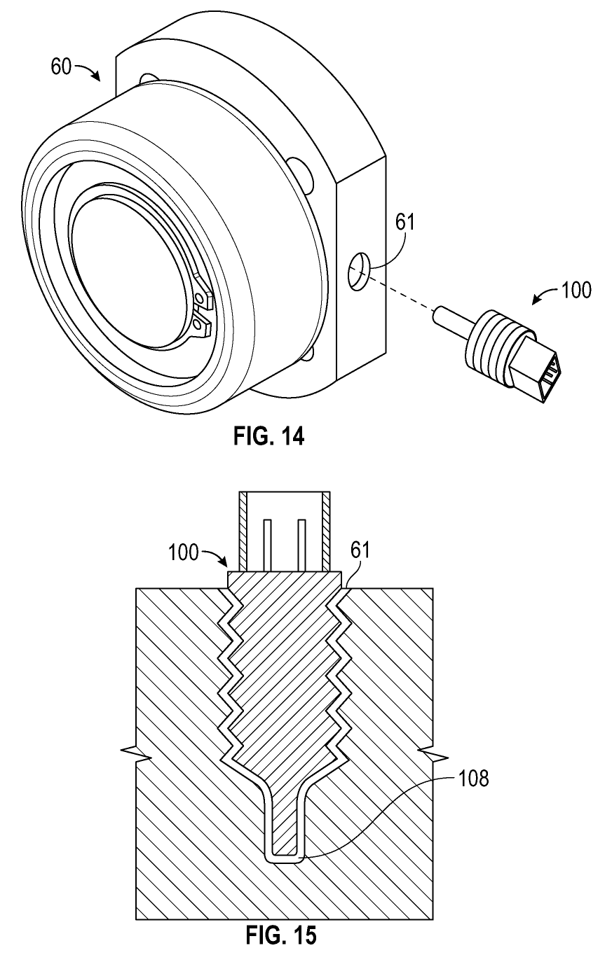

As shown in FIGS. 14 and 15, the temperature sensor 100 may be housed in a threaded ferrule. In this way, the ferrule may be threadedly coupled with the opening 63 such that the temperature sensor is positioned near the surface of or at least partially within the roller 10. As shown in FIGS. 15 and 18, the temperature sensor 100 or the housing for the temperature sensor 100 (e.g., the ferrule) may be coupled with the opening 63 using thermally conductive paste 108. The thermally conductive paste 108 may be epoxy, silicone, polyurethane, or other similar temperature adhesives.

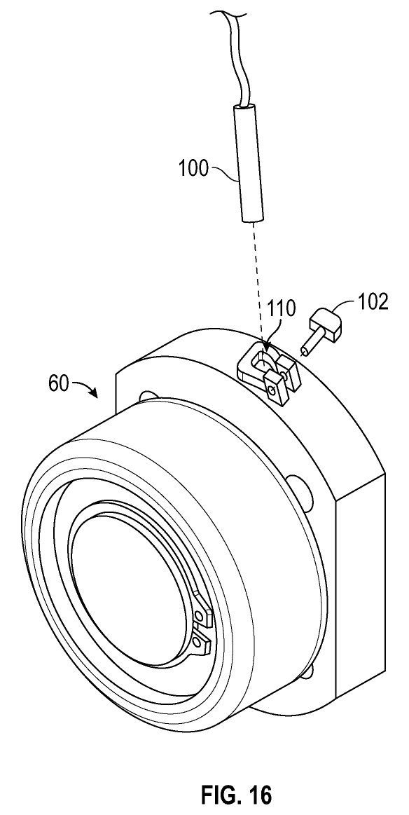

As shown in FIG. 16 the temperature sensor 100 may be inserted into an opening 63 in the roller 60 and secured in place by a compressible clamp 110. The compressible clamp 110 may define an open and closed position. In the open position, the temperature sensor 100 may be inserted into or removed from the opening 63. In the closed position, the temperature sensor 100 may be secured in place within the opening 63. In some examples, the compressible clamp 110 may be coupled with the bolt 102 to further secure the compressible clamp 110 in the downward position.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/-10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments are intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the wear components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body assembly coupled with the chassis;
one or more wear components;
one or more temperature sensors coupled with the one or more wear components; and
a controller having one or more memory devices storing instructions thereon that, when executed by one or more processors, cause the one or more processors to:
acquire data indicative of a temperature of the one or more wear components from the one or more temperature sensors;
acquire a temperature threshold for the one or more wear components;
determine whether the temperature of the one or more wear components satisfies the temperature threshold; and
operate a user device to display the temperature of the wear component in response to determining that the temperature of the wear component fails to satisfy the temperature threshold.

2. The refuse vehicle of claim 1, wherein the temperature threshold is based on at least one of (a) historical temperature data for the one or more wear components, (b) temperature data of additional wear components on the refuse vehicle, or (c) temperature data from additional wear components in a fleet of refuse vehicles.

3. The refuse vehicle of claim 2, wherein the one or more wear components comprise a first wear component and a second wear component, and wherein the instructions cause the one or more processors to:
acquire data indicative of a temperature of the first wear component;
acquire data indicative of a temperature of the second wear component;
compare the temperature of the first wear component to the temperature of the second wear component; and
operate the user device to display the temperature of the first wear component in response to determining that the temperature of the first wear component exceeds the temperature of the second wear component.

4. The refuse vehicle of claim 2, wherein the instructions cause the one or more processors to:
receive data indicative of a temperature of corresponding wear components disposed on a fleet refuse vehicle from a fleet manager;
compare the temperature of the one or more wear components to the temperature of the corresponding wear components disposed on the fleet refuse vehicle; and
operate the user device to display the temperature of the one or more wear components in response to determining that the temperature of the one or more wear components exceed the temperature of the corresponding wear component disposed on the fleet vehicle.

5. The refuse vehicle of claim 1, wherein the one or more wear components are at least one of (a) a roller, (b) a bushing, (c) a wear shoe, or (d) a bearing.

6. The refuse vehicle of claim 1, wherein the one or more temperature sensors are coupled with the wear components using at least one of (a) bolts, (b) threading, (c) clamps, or, (d) thermally conductive paste.

7. The refuse vehicle of claim 1, wherein the one or more wear components include an opening and the one or more temperature sensors are positioned within the opening.

8. The refuse vehicle of claim 1, wherein the one or more temperature sensors coupled with an exterior surface of the one or more wear components.

9. A control system for a vocational vehicle comprising a controller having one or more memory devices storing instructions thereon that, when executed by one or more processors, cause the one or more processors to:
acquire data indicative of a temperature of one or more wear components of the vocational vehicle from one or more temperature sensors;
acquire a temperature threshold for the one or more wear components;
determine whether the temperature of the one or more wear components satisfies the temperature threshold; and
operate a user device to display the temperature of the wear component in response to determining that the temperature of the wear component fails to satisfy the temperature threshold.

10. The control system of claim 9, wherein the one or more memory devices are further configured to store instructions thereon that, when executed by the one or more processors, cause the one or more processors to determine a temperature threshold is based on at least one of (a) historical temperature data for the one or more wear components, (b) temperature data of additional wear components on the vocational vehicle, or (c) temperature data from additional wear components in a fleet of vocational vehicles.

11. The control system of claim 10, wherein the one or more wear components comprise a first wear component and a second wear component, and wherein the one or more memory devices are further configured to store instructions thereon that, when executed by the one or more processors, cause the one or more processors to:
acquire data indicative of a temperature of the first wear component;
acquire data indicative of a temperature of the second wear component;
compare the temperature of the first wear component to the temperature of the second wear component; and
operate the user device to display the temperature of the first wear component in response to determining that the temperature of the first wear component exceeds the temperature of the second wear component.

12. The control system of claim 10, wherein the one or more memory devices are further configured to store instructions thereon that, when executed by the one or more processors, cause the one or more processors to:
receive data indicative of a temperature of corresponding wear components disposed on a fleet vocational vehicle from a fleet manager;
compare the temperature of the one or more wear components to the temperature of the corresponding wear components disposed on the fleet vocational vehicle; and
operate the user device to display the temperature of the one or more wear components in response to determining that the temperature of the one or more wear components exceed the temperature of the corresponding wear component disposed on the fleet vehicle.

13. The control system of claim 9, wherein the one or more wear components are at least one of (a) a roller, (b) a bushing, (c) a wear shoe, or (d) a bearing.

14. The control system of claim 9, wherein the one or more temperature sensors are coupled with the wear components using at least one of (a) bolts, (b) threading, (c) clamps, or, (d) thermally conductive paste.

15. A method for monitoring temperature of wear components in a refuse vehicle, the method comprising:
acquiring data indicative of a temperature of one or more wear components of the refuse vehicle from one or more temperature sensors;
acquiring a temperature threshold for the one or more wear components;
determining whether the temperature of the one or more wear components satisfies the temperature threshold; and
operating a user device to display the temperature of the wear component in response to determining that the temperature of the wear component fails to satisfy the temperature threshold.

16. The method of claim 15, further comprising determining a temperature threshold is based on at least one of (a) historical temperature data for the one or more wear components, (b) temperature data of additional wear components on the refuse vehicle, or (c) temperature data from additional wear components in a fleet of refuse vehicles.

17. The method of claim 15, wherein the one or more wear components comprise a first wear component and a second wear component, and the method further comprising:
acquiring data indicative of a temperature of the first wear component;
acquiring data indicative of a temperature of the second wear component;
comparing the temperature of the first wear component to the temperature of the second wear component; and
operating the user device to display the temperature of the first wear component in response to determining that the temperature of the first wear component exceeds the temperature of the second wear component.

18. The method of claim 17, further comprising:
receiving data indicative of a temperature of corresponding wear components disposed on a fleet refuse vehicle from a fleet manager;
comparing the temperature of the one or more wear components to the temperature of the corresponding wear components disposed on the fleet refuse vehicle; and
operating the user device to display the temperature of the one or more wear components in response to determining that the temperature of the one or more wear components exceed the temperature of the corresponding wear component disposed on the fleet vehicle.

19. The method of claim 15, wherein the one or more wear components are at least one of (a) a roller, (b) a bushing, (c) a wear shoe, or (d) a bearing.

20. The method of claim 15, wherein the one or more temperature sensors are coupled with the wear components using at least one of (a) bolts, (b) threading, (c) clamps, or, (d) thermally conductive paste.
